(19) United States
(12) Patent Application Publication
(10) Pub. No.: US 2010/0058285 A1
(43) Pub. Date: Mar. 4, 2010

(54) COMPOSITIONAL VIEW OF IMPERATIVE OBJECT MODEL

(75) Inventors: Henricus Johannes Maria Meijer, Mercer Island, WA (US); David N. Schach, Redmond, WA (US); Dragos Manolescu, Kirkland, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/199,861

(22) Filed: Aug. 28, 2008

(51) Int. Cl. G06F 9/44

(52) U.S. Cl. 717/104

(57) ABSTRACT

A compositional or alternate object model is employed over an imperative object model to facilitate inspection and construction of imperative structures in a user-friendly manner. Transformations between compositional and imperative models and vice versa can be specified to provide a bridge between differing computing worlds. Moreover, various architectures and/or design patterns can be employed to effect transformation in different ways.

### BACKGROUND

Object-oriented programming is a paradigm that uses objects and interactions amongst objects as a basis for computer program design. In particular, programmers create a number of classes identifying properties and characteristics of an abstract thing as well as methods describing class behavior or abilities. Specific programmatic logic can then be specified as interactions between instances of classes or objects, among other things.

An object model is an object-oriented description of a system, service, or the like. More specifically, an object model is a collection of objects or classes that are available for inspection and manipulation by a program. By way of example, a document object model (DOM) is a collection of objects that represents a browser webpage that enables dynamic modification of the webpage. The DOM is platform and program language independent and facilitates representation of HTML (HyperText Markup Language) and XML (eXtensbile Markup Language) formats, among others. In fact, the World Wide Web Consortium (W3C) specifies a standard DOM that is utilized by most browsers today.

The DOM provides an omnipresent XML object model. In particular, this is the XML object model supported by most browsers, for instance as the “responseXML” attribute of an “XMLHTTP Request”:

```
interface XMLHttpRequest {
    EventListener onreadystatechange;
    short readyState;
  void open(in DOMString method, in DOMString url);
  void open(in DOMString method, in DOMString url, in boolean async);
  void open(in DOMString method, in DOMString url, in boolean async,
in DOMString user);
  void open(in DOMString method, in DOMString url, in boolean async,
in DOMString user, in DOMString password);
  void setRequestHeader(in DOMString header, in DOMString value);
  void send( );
  void send(in DOMString data);
  void send(in Document data);
  void abort( );
  DOMString getAllResponseHeaders( );
  DOMString getResponseHeader(in DOMString header);
  DOMString responseText;
  Document responseXML;
  short status;
  DOMString statusText;
};
```

However, the DOM is a very imperative object model, which enforces a convoluted manner of specifying programs as sequences of side-effect ridden statements. By contrast, compositional object models are much simpler and intuitive, and allow programs to be defined as compositions of expressions. As a result of the DOM's imperative nature, it is not suitable for compositional query and construction.

### SUMMARY

The following presents a simplified summary in order to provide a basic understanding of some aspects of the disclosed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described, the subject disclosure pertains to employment of a compositional view of an imperative object model. More specifically, a compositional or alternate object model can be employed over or as a proxy for an imperative object model such as but not limited to the DOM. Transformations can be performed between the object models to provide a bridge between different worlds. Various systems, architectures, and/or design patterns can be employed to afford transformation, wherein the object models are decoupled, loosely coupled, or tightly coupled. Among other things, this allows developers to program against user-friendly imperative object models as opposed to convoluted imperative models. Moreover, in at least some embodiments this advantage can be attained without modification or even access to an underlying or proxy object model.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 is a block diagram of an object-model interaction system in accordance with an aspect of the claimed subject matter.

FIG. 2 is a block diagram of a representative transformation component according to a disclosed aspect.

FIG. 3 is a graphical illustration of operation of the transformation component according to an aspect of the disclosure.

FIG. 4 is a block diagram of a system for bridging imperative and compositional worlds according to an aspect of the disclosure.

FIG. 5 is a graphical illustration of interaction between imperative and compositional worlds according to a disclosed aspect.

FIG. 6a is block diagram of a system for translating between imperative and compositional aspects according to a disclosed aspect.

FIG. 6b is a graphical illustration of a wrapper pattern employed in accordance with an aspect of the disclosed subject matter.

FIG. 7 is a flow chart diagram of a method of interaction in accordance with an aspect of the disclosure.

FIG. 8 is a flow chart diagram of a method that enables programming against a compositional object model in accordance with an aspect of the disclosed subject matter.

FIG. 9 is a flow chart diagram of a method of enabling programming against a compositional object model according to a disclosed aspect.

FIG. 10 is a flow chart diagram of a method to enable programming against a compositional object model according to an aspect of the disclosure.

FIG. 11 is a schematic block diagram illustrating a suitable operating environment for aspects of the subject disclosure.

FIG. 12 is a schematic block diagram of a sample-computing environment.

### DETAILED DESCRIPTION

Systems and methods concerning employment of a compositional or alternate object model over an imperative object model are described in detail hereinafter. Transformations can be provided between compositional and imperative object model representations. Extension methods can be employed for this purpose. In one instance, the compositional object model can act as a proxy for the imperative object model. Furthermore, various architectures or design patterns can be employed to effect the transformations.

Various aspects of the subject disclosure are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents and alternatives falling within the spirit and scope of the claimed subject matter.

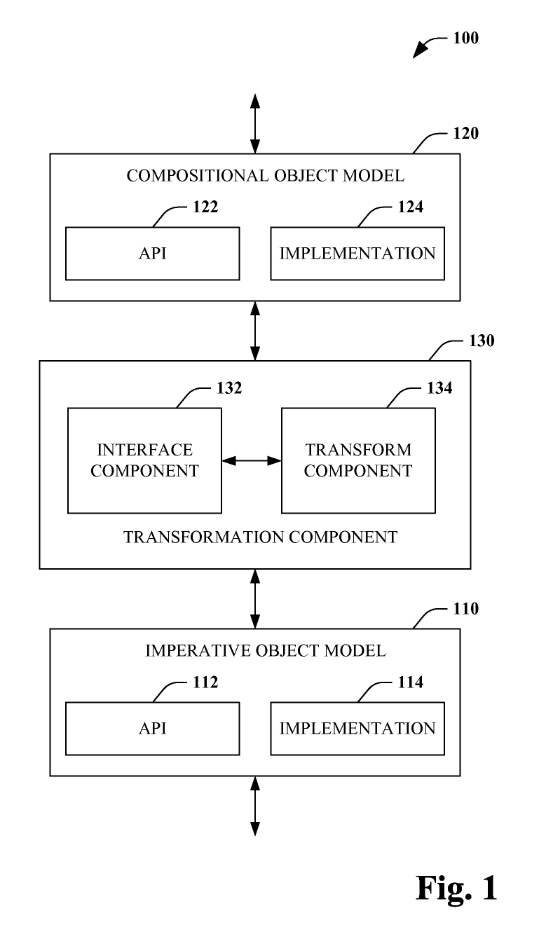

Referring initially to FIG. 1, an object-model interaction system 100 is illustrated in accordance with an aspect of the claimed subject matter. The system 100 includes imperative object model 110 and compositional object model 120 (each of which is a component as defined herein). The imperative object model 110 provides a description of a system, service, construct, or the like in an imperative style (statement-oriented). In furtherance thereof, the imperative object model 110 comprises an application-programming interface (API) 112 (a component as defined herein) and an implementation 114 (a component ad defined herein). The API 112 describes functions, procedures, or the like exposed for utilization and defined by implementation 114.

Similar to the imperative object model 110, the compositional object model 120 provides a description of a system, service, construct, or the like. However, the compositional object model 120, as the name suggests, is compositional (expression-oriented) in style rather than imperative. Further, the compositional object model 120 includes application-programming interface (API) 122 (a component as defined herein) that identifies functions, procedures, or the like defined by implementation 224 (a component as defined herein) that can be employed or called by a program or other entity.

In accordance with one aspect, the imperative object model 110 and the compositional object model 110 can relate to the same service, construct, or the like. By way of example and not limitation, both the imperative object model 110 and the compositional object model 120 can correspond to an XML object model that enables interaction with an XML document.

It is often desirous to utilize a compositional object model 110 rather than an imperative object model 120, since it is more intuitive and user friendly by virtue of its declarative and compositional nature than a rigid step-by-step imperative approach. However, some systems are tightly bound with an imperative object model 110. For instance, a majority of web browsers support a standard document object model that supports XML, among other things. In such instances, one is not likely to be able to simply swap an imperative object model 110 for a compositional object model. However, in accordance with an aspect of the claimed subject matter, the compositional object model 120 can be employed in conjunction with and/or over the imperative object model 110. In effect, the compositional object model 120 can act as a proxy for the imperative object model thereby leveraging the benefits of the compositional style.

Differences between the imperative object model 110 and the compositional object model 120 can be addressed by transformation component 130 via transformation or mapping between the object models. In particular, the transformation component includes an interface component 132 and transform component 134. The interface component 132 can receive or otherwise identify operations or calls from an object model such as the compositional object model 120 and provide them to the transform component 134 that transforms compositional actions into imperative actions with respect to the imperative object model 110. Of course, the opposite is also possible, in which the transformation component 130 acquires imperative actions and transforms them into compositional actions. As will be discussed further below and in accordance with another aspect, transformation can be performed with extension methods.

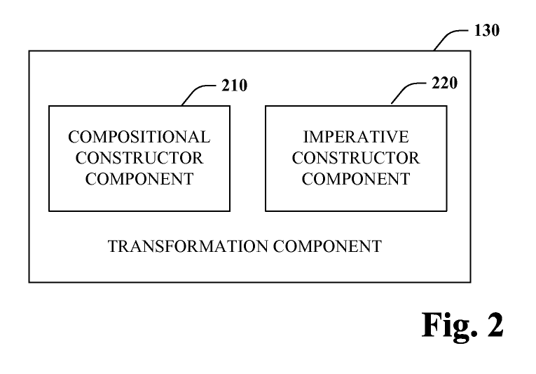

Various architectures, design patterns or the like can be employed with respect employing a compositional or alternate object model 120 over an imperative object model. Turning to FIG. 2, a representative transformation component 130 is illustrated in accordance with one embodiment. As shown, the transformation component 130 includes two components, namely a compositional constructor component 210 and an imperative constructor component 220. The compositional constructor 210 constructs or otherwise produces a compositional representation of an object, construct, or the like from an imperative representation of the same. Similarly, the imperative constructor component 220 produces an imperative representation of an object, construct, or the like from a compositional representation.

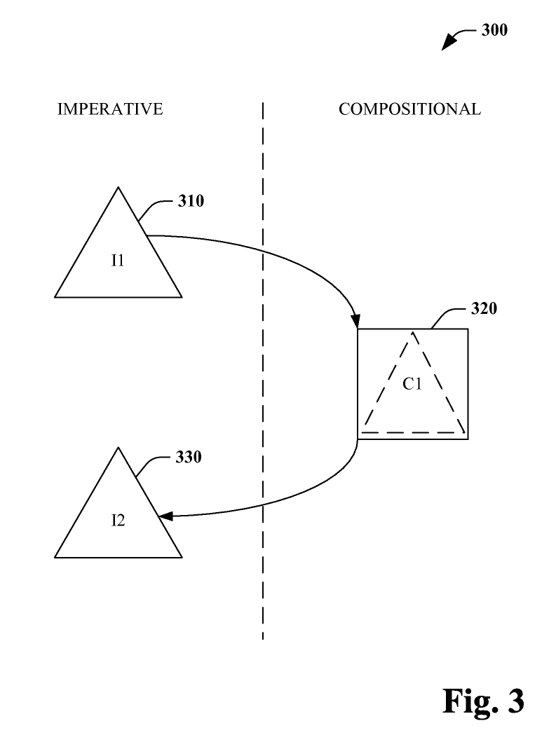

FIG. 3 is a graphical illustration of the operation of the compositional constructor component 210 and imperative constructor component 220 according to one exemplary architecture or pattern. As depicted, imperative representations are shown as triangles and a compositional representation is illustrated as a square. For example, the triangles can correspond to DOM trees and the square and XML object model representation thereof. A first imperative representation “I1” 310 can be transformed or “serialized” to a compositional representation “C1” 320. Users can examine and/or modify the compositional representation “C1” 320 rather than the imperative representation “1” 310. Subsequently, a modified version of the compositional representation “C1” 320 can be transformed into a new imperative representation “I2” 330 that replaces the first imperative representation “I1” 310.

Appendix A provides exemplary code for converting a DOM tree into an alternate compositional XML object model. In general, the compositional XML object model can include several methods to load as well as print or save documents. For instance, data can be loaded from a string or an XML reader employed and written to a string or output by an XML writer. In accordance with a disclosed aspect, the repertoire of loading and writing, printing or saving can be extended to support reading and writing a DOM tree. Further, the “GetContent” method illustrates one example of how the imperative and compositional worlds can be bridged. In particular, a switch construct is employed that switches on DOM nodes and produces compositional XML nodes.

One issue with this type of architecture is that the imperative and compositional structures may not be synchronized. After the first imperative structure is converted into a compositional structure, many modifications can be made which will not be reflected in the imperative world until another imperative structure is generated that captures the current state. Further, it is not very efficient to require complete regeneration of imperative structures. Nevertheless, this is one possible manner of interaction in which the imperative and compositional object model are decoupled and a type of serialization and/or deserialization employed.

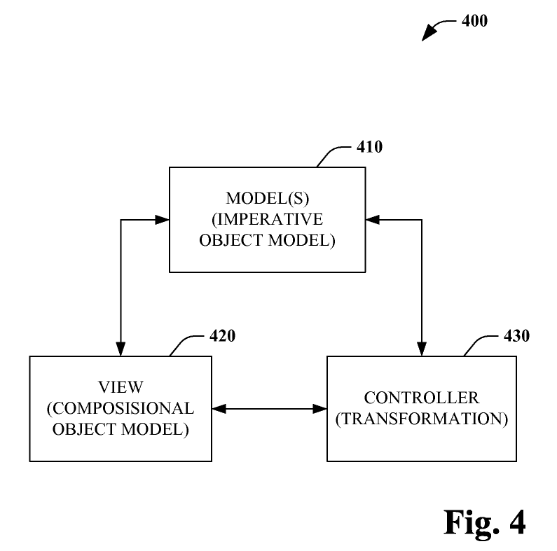

FIG. 4 depicts a system or architecture 400 for bridging imperative and compositional worlds in accordance with an aspect of the claimed subject matter. As depicted, the system 400 includes three components model(s) 410, view 420, and controller 430 corresponding to a type of model-view-controller design pattern. Here, the imperative object model can correspond to a model 410, the compositional or alternate object model corresponds to the view 420, and transformation functionality maps to the controller 430. In other words, the compositional object model provides a view of an imperative object model. Further, the controller can monitor the view 420 and update the model 410 such that modifications to the view 420 are immediately visible in the model 410. This is beneficial in that state is substantially synchronized and the process need not construct and save an entire structure.

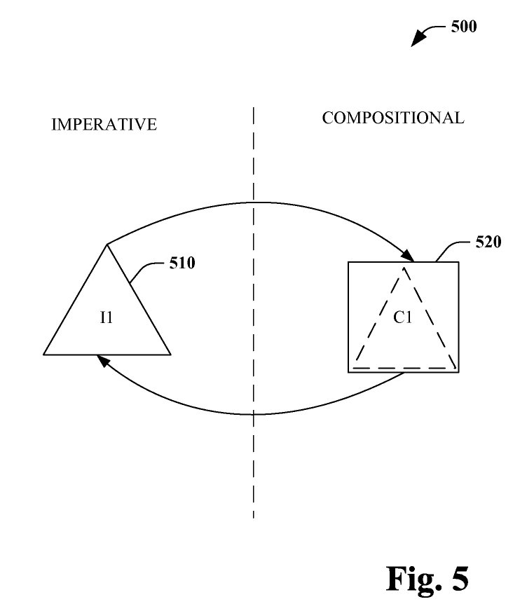

FIG. 5 provides a graphical depiction 500 of operation of the system 400 to facilitate clarity and understanding with respect to aspects of the claimed subject matter. An imperative structure “I1” 510 can be translated or transformed into a compositional structure “C1” 520 to provide a compositional view and interface for interacting with the compositional structure. Upon receipt or identification of a changed made the compositional structure 520, the imperative structure 510 can be updated to reflect this change.

It should be appreciated that while system 400 of FIG. 4 can correspond to a model-view-design pattern, this pattern is being utilized in a very different context here. Traditionally, a view represents a user interface rendering or presentation of data captured by a single model. For example, the model can capture time and the view can present an analog or digital clock to display the time. Here, the pattern is much more abstract. For example, the model 410 can correspond to an imperative object model and associated state over which a compositional object model 420 is employed as a view. With the controller 430, it is possible to submit changes or interactions with the view 420 to the model 410. For instance, when interacting with a view, if a node is added, the controller 430 will be notified, or otherwise identify the change, and the model 410 will be updated with the newly added node such that the model 410 and view 420 are synchronized.

Furthermore, conventional model-view-controller patterns focus on a single model with one or more views. Here, the opposite is true, where one view is to be employed over one or more models (albeit not necessarily at the same time). For example, web browsers may implement a document object model in slightly different manners. However, any differences or idiosyncrasies can be avoided by interacting with a single view or associated object model.

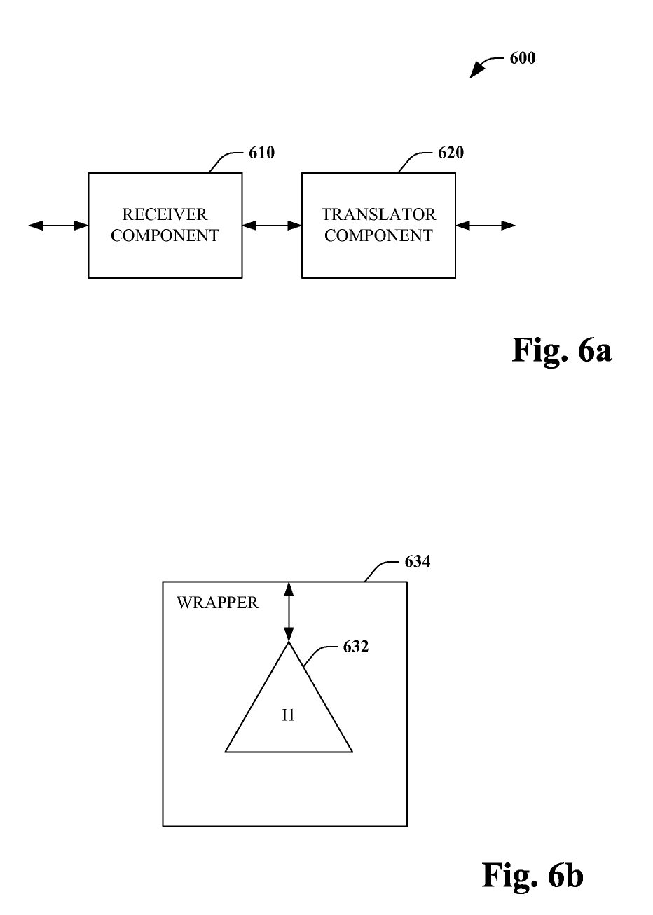

Turning to FIG. 6a, another system or architecture 600 is illustrated for object model interaction. The system 600 includes a receiver component 610 and a translator component 620. The receiver component 610 receives an imperative action or call for example from a program or other entity interacting with an imperative API or corresponding object model. The received action is then translated or converted to an imperative action or call by the translator component 620. Accordingly, a compositional representation need not be employed. Rather, calls can be directly translated to imperative object model understood calls for execution. Hence, the system 600 can correspond to a wrapper or adapter design pattern. As depicted graphically in FIG. 6b, any compositional action specified for an imperative representation “I1” 632 will be intercepted by the wrapper component 624 and translated to appropriate, imperative object model or API calls. Of course, the link can be bidirectional such that returned elements, events and the like can be bubbled up in a compositional representation.

What has been presented is a spectrum of possibilities relating to employment of imperative or alternate object model over or as a proxy for an imperative object model. Specifically, interactions can vary in degrees between loose and tight coupling. For example, employment of a model-view-controller pattern is looser in coupling than a wrapper pattern but tighter than simple serialization or transformation between constructs. It is to be appreciated that this is only a sample of the manners in which object models can interact. Other systems, architectures, and/or design patters are also possible and are to be deemed within the scope of innovation including but not limited to bridge, facade or proxy patterns.

Interactions between object models including transformations, translations, conversions or the like can be embodied or implemented by extension methods or the like in accordance with one aspect of the claimed subject matter. Extension methods enable new methods to be added to types or classes without requiring recompilation of the original type. This is especially helpful where an object model or functionality associated there with is inaccessible or unable to be modified.

In particular, it may be desirable to connect two different object models, APIs or the like that are designed and implemented completely independent of each other. In other words, they are unaware of each other. Extension methods provide a mechanism to make this connection after the fact. The object models, APIs, or the like can be related without changing them.

Furthermore and in accordance with an aspect of the disclosure, an object model sought to be employed as a view over another object model can generate events that aid in building a bridge between the models. For example, an event can be raised or fired just before something is changed and after the change is complete. Since events are fired just before and after a change, the difference or delta can be computed to identify what has changed. Using event handlers, changes can be made to an underlying model state, structure, or representation. By way of example and not limitation, in a model-view-controller pattern changes in the view can be detected by raised events, which can subsequently be employed to update the model.

It is also to be appreciated that conversions, transformations, translations, or the like can leverage functionality exposed by an underlying object model, API and/or the like. For example, the open method of the “XMLHTTP” object of an underlying document object model can be considered an asynchronous factory method for DOM trees. Where a compositional or alternative object model does not support such asynchronous processing but rather is synchronous in nature, a transformation can expose and/or leverage such functionality in the underlying DOM.

The aforementioned systems, architectures, and the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. Communication between systems, components and/or sub-components can be accomplished in accordance with either a push and/or pull model. The components may also interact with one or more other components not specifically described herein for the sake of brevity, but known by those of skill in the art.

Furthermore, as will be appreciated, various portions of the disclosed systems above and methods below can include or consist of artificial intelligence, machine learning, or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent. By way of example and not limitation, such mechanisms can be employed to automatically infer transformations representations and/or leverage functionality associated with an underlying implementation.

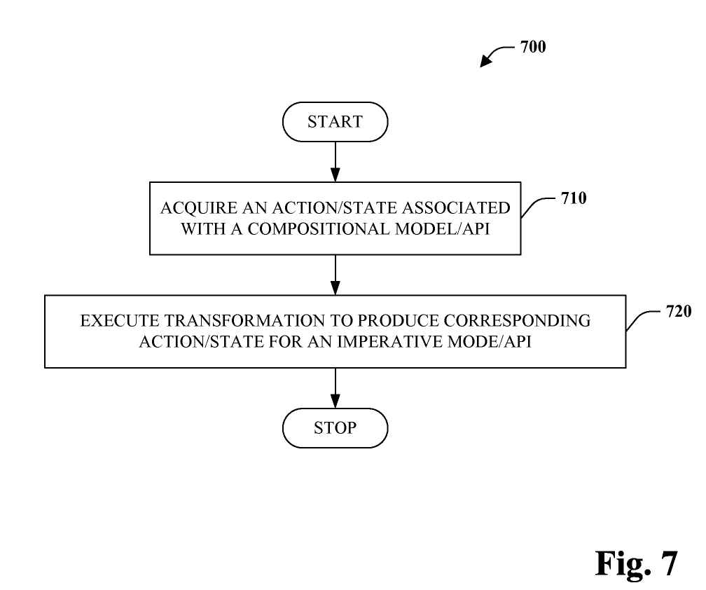

In view of the exemplary systems described supra, methodologies that may be implemented in accordance with the disclosed subject matter will be better appreciated with reference to the flow charts of FIGS. 7-10. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

Referring to FIG. 7, a method of interaction 700 is illustrated in accordance with an aspect of the claimed subject matter. At reference numeral 710, an action or state associated with a compositional object model, API or the like is acquired. For example, computer program can make a call to avail itself of services provided by a particular method. At numeral 720, a transformation is executed to transform, translate, or convert the action or state to a corresponding action or state associated with an imperative object model, API, or the like. In this manner, a more declarative and compositional mechanism can be employed on top of or as a proxy for a more formalistic imperative implementation. Of course, transformation can be bi-directional to enable imperative responses to be viewed and processed appropriately.

By way of example and not limitation, consider a scenario in which it is desired that an XML document be dynamically produced for a page within a web browser, and the document object model associated with the browser affords an imperative API for such purpose. While this can certainly be employed to produce the XML document, it is not the most developer friendly manner of document production due to the rigid and convoluted nature of imperative programming. Alternatively, a compositional object model and/or associated API can be targeted to take advantage of the declarative and/or compositional nature of compositional programming. Subsequently, compositional actions and/or state can be transformed into the imperative world. For instance, compositional API calls can be transformed to imperative API calls or a produced document can be transformed or serialized to an imperative structure.

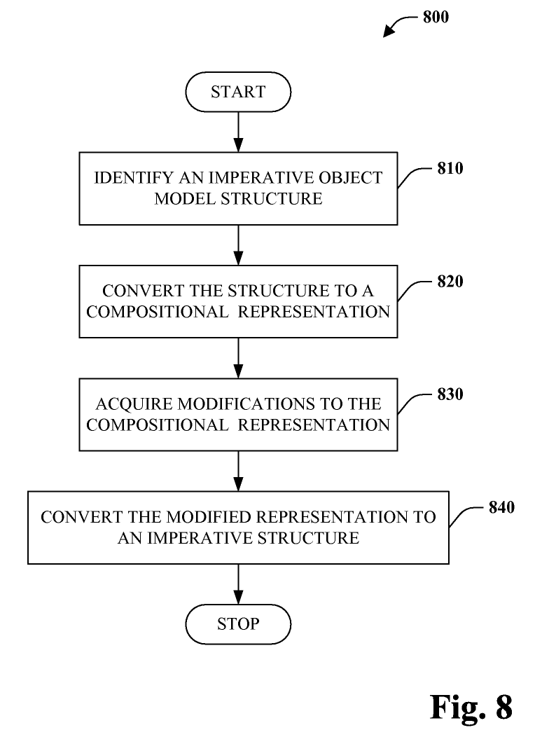

FIG. 8 illustrates a method 800 that enables programming against a compositional object model in accordance with an aspect of the claimed subject matter. At reference numeral 810 an imperative object model state or structure is identified. The structure is converted to a compositional representation associated with a compositional object model, and/or API, or the like. At reference 830, modifications are acquired or made to the compositional representation utilizing compositional mechanisms (e.g., methods, procedures, functions . . . ). The modified structure is converted to an imperative structure at reference numeral 840. In one instance, conversion to and from object model representations can be embodied as a serialization and/or deserialization operations. Here, the compositional object model providing a view or abstraction is very loosely coupled or decoupled from the imperative object model affording a model or implementation.

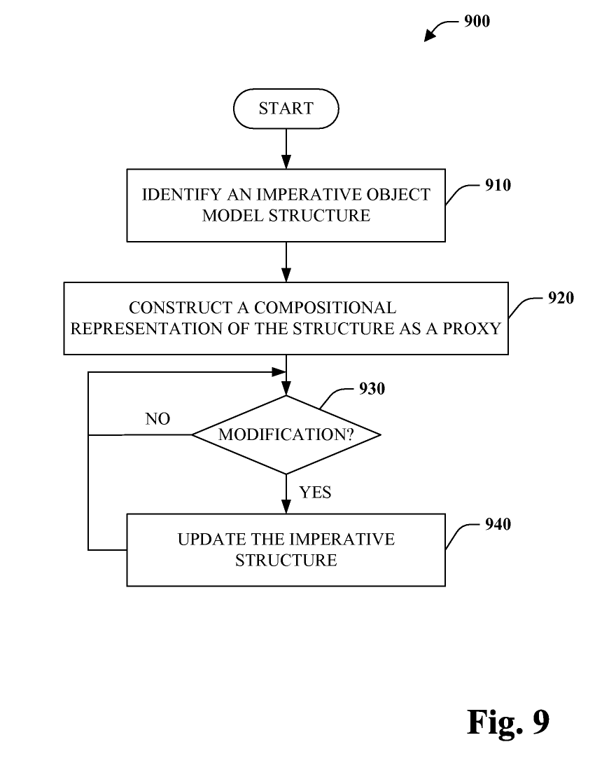

FIG. 9 depicts a method 900 of enabling programming against a compositional object model according to an aspect of the claimed subject matter. More specifically, the method 900 illustrates implementation version of a model-view-controller design pattern. At reference numeral 910, an imperative object model state or structure is identified. At numeral 920, a compositional representation of the structure is constructed to act as a proxy for the imperative structure. For example, the imperative object model structure can be serialized and/or deserialized to the compositional representation. At reference numeral, 930, a determination is made as to whether a modification has been made to the compositional representation. In one implementation, for example, modification can generate events indicative of change. Further, the actual modification can be determined as a function of the difference before and after a change. If modification is detected or inferred, the imperative structure is updated such that it is synchronized with the compositional representation at numeral 940 and it returns to 930. If, at 930, a modification is not detected, the method 900 can simply loop until one is detected or the representation released for garbage collection, for instance.

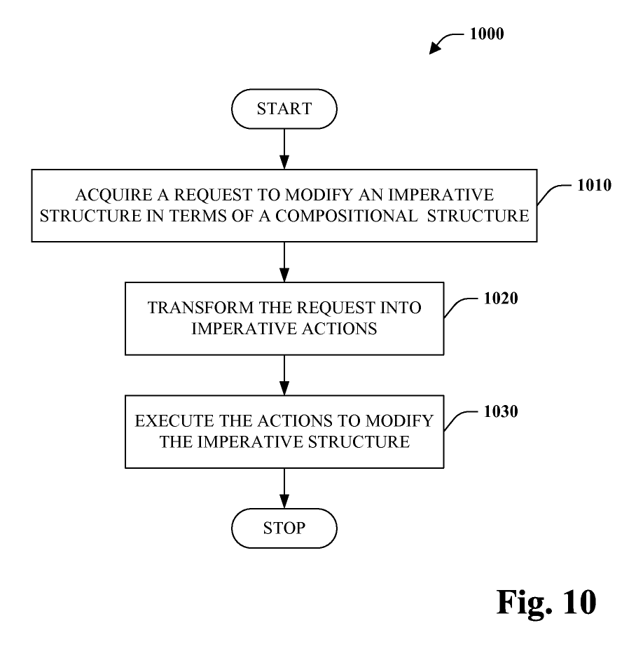

FIG. 10 is a flow chart diagram of a method 1000 that enables interaction with or programming against a compositional object model according to an aspect of the claimed subject matter. At reference numeral 1010, a request is acquired to modify an imperative structure in terms of a compositional structure. In other words, a compositional object model and/or API are acting as a proxy, view, or abstraction over an imperative object model and/or API. At numeral 1020, the request is transformed into an imperative action or actions. In one instance, a compositional method call is mapped to one or more imperative method calls of equivalent semantics. Additionally or alternatively, differing or unique imperative functionality can be leveraged for purposes of efficiency, among other things. For example, asynchronous operations can be tier split across execution contexts or concurrently processed. The action(s) are executed at 1030 to modify the imperative structure.

Disclosed aspects have been described with respect to a browser DOM and compositional XML object model to facilitate clarity and understanding. It is to be appreciated that there are various other concrete instances that benefit from implementing a compositional object model or the like over an imperative object model. By way of example and not limitation, consider an imperative API associated with generation of graphical user interface elements such as buttons that requires a specific form or sequence of actions to construct the elements and a compositional API designed for a similar purpose. Where one desires to construct elements in more of a declarative and compositional manner, the compositional API can be layered on top of the imperative API.

Further yet, aspects of the disclosure are applicable to any scenario in which one representation is viewed as or through another representation. In other words, there can be an abstraction and an implementation. By way of example and not limitation, there is applicability to versioning. Suppose there is a first version of a library and a newer second version of the library and one desires that individuals program against the newer second version but in terms of the old first version.

The word “exemplary” or various forms thereof are used herein to mean serving as an example, instance, or illustration. Any aspect or design described herein as “exemplary” is not necessarily to be construed as preferred or advantageous over other aspects or designs. Furthermore, examples are provided solely for purposes of clarity and understanding and are not meant to limit or restrict the claimed subject matter or relevant portions of this disclosure in any manner. It is to be appreciated that a myriad of additional or alternate examples of varying scope could have been presented, but have been omitted for purposes of brevity.

As used herein, the term “inference” or “infer” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the subject innovation.

Furthermore, all or portions of the subject innovation may be implemented as a method, apparatus or article of manufacture using standard programming and/or engineering techniques to produce software, firmware, hardware, or any combination thereof to control a computer to implement the disclosed innovation. The term “article of manufacture” as used herein is intended to encompass a computer program accessible from any computer-readable device or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

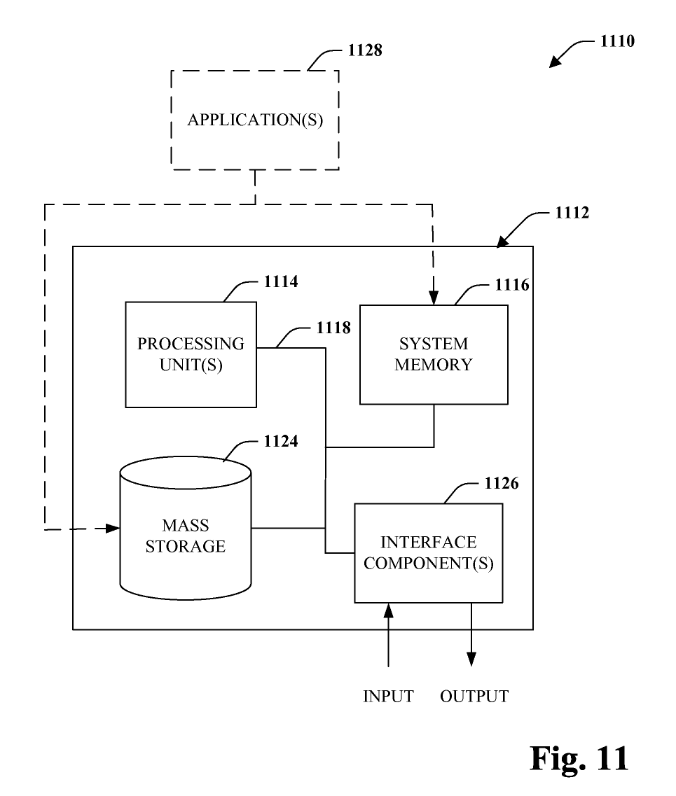

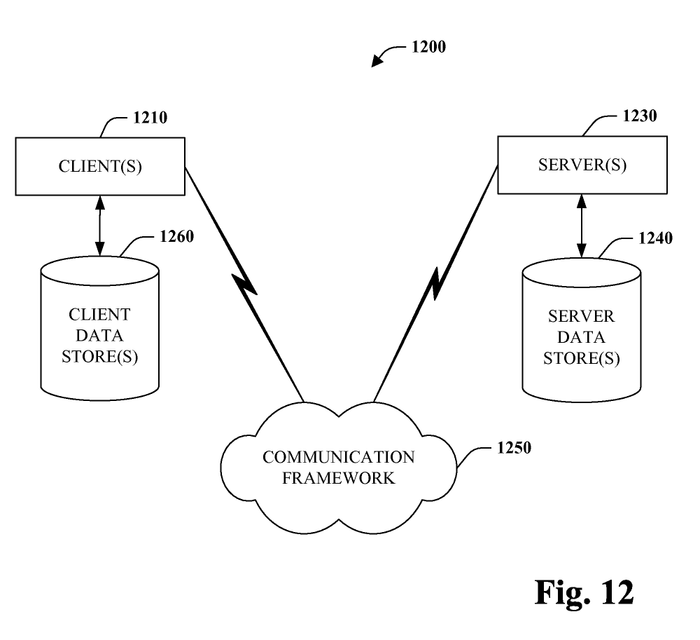

In order to provide a context for the various aspects of the disclosed subject matter, FIGS. 11 and 12 as well as the following discussion are intended to provide a brief, general description of a suitable environment in which the various aspects of the disclosed subject matter may be implemented. While the subject matter has been described above in the general context of computer-executable instructions of a program that runs on one or more computers, those skilled in the art will recognize that the subject innovation also may be implemented in combination with other program modules. Generally, program modules include routines, programs, components, data structures, etc. that perform particular tasks and/or implement particular abstract data types. Moreover, those skilled in the art will appreciate that the systems/methods may be practiced with other computer system configurations, including single-processor, multiprocessor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the claimed subject matter can be practiced on stand-alone computers. In a distributed computing environment, program modules may be located in both local and remote memory storage devices.

With reference to FIG. 11, an exemplary environment 1110 for implementing various aspects disclosed herein includes a computer 1112 (e.g., desktop, laptop, server, hand held, programmable consumer or industrial electronics . . . ). The computer 1112 includes a processing unit 1114, a system memory 1116, and a system bus 1118. The system bus 1118 couples system components including, but not limited to, the system memory 1116 to the processing unit 1114. The processing unit 1114 can be any of various available microprocessors. It is to be appreciated that dual microprocessors, multi-core and other multiprocessor architectures can be employed as the processing unit 1114.

The system memory 1116 includes volatile and nonvolatile memory. The basic input/output system (BIOS), containing the basic routines to transfer information between elements within the computer 1112, such as during start-up, is stored in nonvolatile memory. By way of illustration, and not limitation, nonvolatile memory can include read only memory (ROM). Volatile memory includes random access memory (RAM), which can act as external cache memory to facilitate processing.

Computer 1112 also includes removable/non-removable, volatile/non-volatile computer storage media. FIG. 11 illustrates, for example, mass storage 1124. Mass storage 1124 includes, but is not limited to, devices like a magnetic or optical disk drive, floppy disk drive, flash memory, or memory stick. In addition, mass storage 1124 can include storage media separately or in combination with other storage media.

FIG. 11 provides software application(s) 1128 that act as an intermediary between users and/or other computers and the basic computer resources described in suitable operating environment 1110. Such software application(s) 1128 include one or both of system and application software. System software can include an operating system, which can be stored on mass storage 1124, that acts to control and allocate resources of the computer system 1112. Application software takes advantage of the management of resources by system software through program modules and data stored on either or both of system memory 1116 and mass storage 1124.

The computer 1112 also includes one or more interface components 1126 that are communicatively coupled to the bus 1118 and facilitate interaction with the computer 1112. By way of example, the interface component 1126 can be a port (e.g., serial, parallel, PCMCIA, USB, FireWire . . . ) or an interface card (e.g., sound, video, network . . . ) or the like. The interface component 1126 can receive input and provide output (wired or wirelessly). For instance, input can be received from devices including but not limited to, a pointing device such as a mouse, trackball, stylus, touch pad, keyboard, microphone, joystick, game pad, satellite dish, scanner, camera, other computer and the like. Output can also be supplied by the computer 1112 to output device(s) via interface component 1126. Output devices can include displays (e.g., CRT, LCD, plasma . . . ), speakers, printers and other computers, among other things.

FIG. 12 is a schematic block diagram of a sample-computing environment 1200 with which the subject innovation can interact. The system 1200 includes one or more client(s) 1210. The client(s) 1210 can be hardware and/or software (e.g., threads, processes, computing devices). The system 1200 also includes one or more server(s) 1230. Thus, system 1200 can correspond to a two-tier client server model or a multi-tier model (e.g., client, middle tier server, data server), amongst other models. The server(s) 1230 can also be hardware and/or software (e.g., threads, processes, computing devices). The servers 1230 can house threads to perform transformations by employing the aspects of the subject innovation, for example. One possible communication between a client 1210 and a server 1230 may be in the form of a data packet transmitted between two or more computer processes.

The system 1200 includes a communication framework 1250 that can be employed to facilitate communications between the client(s) 1210 and the server(s) 1230. The client(s) 1210 are operatively connected to one or more client data store(s) 1260 that can be employed to store information local to the client(s) 1210. Similarly, the server(s) 1230 are operatively connected to one or more server data store(s) 1240 that can be employed to store information local to the servers 1230.

Client/server interactions can be utilized with respect to various aspects of the claimed subject matter. By way of example and not limitation, one or more components can function as a network or web service provided by one or more servers 1230 to one or more clients 1210 across the communication framework 1250. For instance, transformation logic that provides a bridge between object models or the like can be embodied as a web service. Furthermore, where loosely coupled or decoupled architectures, design patters or the like are employed a view and a model or an abstraction and an implementation can be resident on different servers 1230 and/or clients 1210 and communicate by way of the communication framework 1250.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications and variations that fall within the spirit and scope of the appended claims. Furthermore, to the extent that the terms “includes,” “contains,” “has,” “having” or variations in form thereof are used in either the detailed description or the claims, such terms are intended to be inclusive in a manner similar to the term “comprising” as “comprising” is interpreted when employed as a transitional word in a claim.

```
APPENDIX A
using System;
using System.Collections.Generic;
using System.Linq;
using System.Text;
using System.Xml.Linq;
using Volta.Xml;
namespace System.Xml.Linq
{
    public class DOMConverter
    {
        public static XDocument LoadXml(string xml)
        {
            var doc = new Volta.Xml.XmlDocument( );
            doc.Async = false;
            doc.ValidateOnParse = false;
            doc.ResolveExternals = false;
            doc.LoadXml(xml);
            var converter = new DOMConverter( );
            return converter.GetDocument(doc);
        }
        public static XDocument
LoadDocument(Volta.Xml.XmlDocument doc)
        {
            var converter = new DOMConverter( );
            return converter.GetDocument(doc);
        }
        public static XDocument LoadDocument(string uri)
        {
            var doc = Load(uri);
            XmlParseError parseError = null;
            if (doc.ParseError.ErrorCode != 0)
            {
                parseError = doc.ParseError;
            }
            var converter = new DOMConverter( );
            return converter.GetDocument(doc);
        }
        public static XElement LoadElement(string uri)
        {
            var doc = Load(uri);
            XmlParseError parseError = null;
            if (doc.ParseError.ErrorCode != 0)
            {
                parseError = doc.ParseError;
            }
            var converter = new DOMConverter( );
            return converter.GetElement(doc);
        }
        static Volta.Xml.XmlDocument Load(string uri)
        {
            var doc = new Volta.Xml.XmlDocument( );
            doc.Async = false;
            doc.ValidateOnParse = false;
            doc.ResolveExternals = false;
            doc.Load(uri);
            return doc;
        }
        XElement GetElement(Volta.Xml.XmlDocument doc)
        {
            return GetElement(doc.DocumentElement);
        }
        XDocument GetDocument(Volta.Xml.XmlDocument doc)
        {
            var d = new XDocument( );
            var first = doc.FirstChild;
            if (first != null &&
                first.NodeType  ==
Volta.Xml.XmlNodeType.ProcessingInstruction &&
                first.NodeName.Equals(“xml”))
                first = first.NextSibling;
            GetContent(d, first);
            return d;
        }
        XElement GetElement(Volta.Xml.XmlElement domElement)
        {
            var namespaceUri = domElement.NamespaceUri;
            var e = new
XElement(XName.Get(domElement.BaseName, namespaceUri !=
null ? namespaceUri : “”));
            // Get Attributes
            var domAttributes = domElement.Attributes;
            for (Volta.Xml.XmlNode domAttribute =
domAttributes.NextNode( ); domAttribute != null; domAttribute =
domAttributes.NextNode( ))
            {
                var prefix = domAttribute.Prefix;
                var baseName = domAttribute.BaseName;
                var value = domAttribute.Text;
                XAttribute a;
                if (prefix != null && prefix.Equals(“xmlns”))
                {
                    if (baseName.Length == 0)
                    {
                        a = new XAttribute(prefix, value);
                    }
                    else
                    {
                        a = new XAttribute(XNamespace.Xmlns +
baseName, value);
                    }
                }
                else
                {
                    namespaceUri = domAttribute.NamespaceUri;
                    a = new XAttribute(XName.Get(baseName,
namespaceUri != null ? namespaceUri : “”), value);
                }
                e.Add(a);
            }
            // Get Content
            if (domElement.HasChildNodes( ))
            {
                GetContent(e, domElement.FirstChild);
            }
            return e;
        }
        void GetContent(XContainer c, Volta.Xml.XmlNode domNode)
        {
            XNode n;
            for (; domNode != null; domNode = domNode.NextSibling)
            {
                switch (domNode.NodeType)
                {
                    case Volta.Xml.XmlNodeType.Element:
                        n = GetElement(domNode as
Volta.Xml.XmlElement);
                        break;
                    case Volta.Xml.XmlNodeType.Text:
                        n = new XText(domNode.Text);
                        break;
                    case Volta.Xml.XmlNodeType.CData:
                        n = new XCData(domNode.Text);
                        break;
                    case Volta.Xml.XmlNodeType.Comment:
                        n = new XComment(domNode.Text);
                        break;
                    case Volta.Xml.XmlNodeType.-
                    ProcessingInstruction:
                        n = new
XProcessingInstruction(domNode.NodeName, domNode.Text);
                        break;
                    default:
                        n = null;
                        break;
                }
                if (n != null)
                    c.Add(n);
            }
        }
    }
}
```

What is claimed is:

1. A computer system that facilitates object model interaction, comprising:
a component that acquires a compositional application-programming interface (API) call associated with a compositional object model; and
a transform component that transforms the compositional API call into an equivalent imperative API call associated with an imperative object model thereby providing a bridge between the models that enables compositional interaction with an imperative object model.

2. The system of claim 1, the transform component transforms an imperative structure to a representative compositional structure for inspection and/or alteration.

3. The system of claim 2, the transform component generates a new imperative structure from the representative compositional structure to capture changes made.

4. The system of claim 1, the components are included in a controller of a model-view-controller pattern, the compositional object model corresponds to the view, and the imperative object model corresponds to the model.

5. The system of claim 1, the components form part of an adapter or wrapper pattern.

6. The system of claim 1, the transformation component employs one or more extension methods to add functionality without altering the object models.

7. The system of claim 6, the extension methods leverage change events raised by the compositional object model to identify changes.

8. The system of claim 1, the imperative object model is a document object model associated with a web browser.

9. The system of claim 8, the compositional object model enables generation and interaction with extensible markup language constructs.

10. A method of interacting with imperative object models, comprising:
receiving calls through a compositional object model as a proxy for an imperative object model; and
bridging differences between the compositional object model and the imperative object model.

11. The method of claim 10, further comprising employing one or more extension methods to bridge the differences.

12. The method of claim 11, further comprising constructing a compositional representation of the imperative construct.

13. The method of claim 12, further comprising generating a new imperative construct to capture changes to the compositional representation.

14. The method of claim 11, further comprising updating the imperative construct to reflect changes to the compositional representation.

15. The method of claim 11, the compositional object model exposes events pertaining to changes that are leveraged by the one or more extension methods.

16. The method of claim 10, further comprising mapping compositional calls to equivalent imperative calls while leveraging unique imperative functionality.

17. The method of claim 10, further comprising bridging the difference between a compositional extensible markup language representation and an extensible markup language document object model associated with a browser.

18. A method of data interaction across differing model styles, comprising:
identifying an imperative, document object model structure; and
converting the structure into a compositional representation with extension methods, the compositional representation acts as a proxy for the structure.

19. The method of claim 18, further comprising converting the compositional representation into an imperative, document-object-model structure with extension methods.

20. The method of claim 18, further comprising identifying a change in the compositional representation as a function of events raised by an associated compositional object model, and updating imperative structured with the change.
